(19) United States
(12) Patent Application Publication
(10) Pub. No.: US 2014/0241380 A1
(43) Pub. Date: Aug. 28, 2014

(54) MEDIA STREAM OVER PASS THROUGH MECHANISM

(71) Applicants: Joseph A. Bennett, Roseville, CA (US); Guoging Li, Portland, OR (US); Vallabhajosyula S. Somayazulu, Portland, OR (US); George R. Hayek, El Dorado Hills, CA (US); Gideon Prat, Haifa (IL); Srikanth Kambhatla, Portland, OR (US)

(72) Inventors: Joseph A. Bennett, Roseville, CA (US); Guoging Li, Portland, OR (US); Vallabhajosyula S. Somayazulu, Portland, OR (US); George R. Hayek, El Dorado Hills, CA (US); Gideon Prat, Haifa (IL); Srikanth Kambhatla, Portland, OR (US)

(21) Appl. No.: 13/992,451

(22) PCT Filed: Nov. 17, 2011
(86) PCT No.: PCT/US11/61283

§ 371 Date: Mar. 10, 2014

Related U.S. Application Data
(60) Provisional application No. 61/441,752, filed on Feb. 11, 2011.

(51) Int. Cl. H04L 29/06

(52) U.S. Cl. CPC H04L 69/22
USPC 370/474

(57) ABSTRACT

A data packet or payload defined by a first format, is generated and is wrapped with headers as defined by a second format, and is processed through a pass through mechanism for transmission based on the second format. The processing includes adding or encapsulating the payload in the transmission data packet. When receiving the transmitted data packet, the headers may be parsed, and the payload processed.

### BACKGROUND

Evolving transmission specifications, such as the Wireless Gigabit Alliance (WGA) or WiGi specification will be implemented on various devices to support wireless display over 60 GHz radio link.

Devices that implement the evolving WiGi specification may also implement other specifications to communicate and transmit audio and video data. For example, the Moving Pictures Experts Group (MPEG) defines specifications to communicate audio and video over devices, such as computing devices. MPEG provides specifications which define processes to packetize and communicate audio and video data to and from devices. MPEG packets may be communicated through wired and wireless connections/communications, such as Institute of Electrical and Electronics Engineers or IEEE 802.11 (also known as WiFi) defined radio interfaces. For example, an MPEG-TS (transport stream) format may be used to provide video (typically compressed) and/or audio bit streams. Such MPEG-TS packets can be further packetized through successive layers, where each layer provides headers. Such layers include Real-time Transport Protocol (RTP), User Datagram Protocol (UDP) and Internet Protocol (IP), where each layer may provide a header to the packet. The packet may be processed through a WiFi radio of the device for transmission. Transmission over a WiFi radio may occur over a 2.4 GHz or 5.0 GHz spectrum.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a block diagram of an example system architecture to communicate media stream packets over a pass through mechanism between transmitting and receiving devices.

FIG. 2 is a block diagram of an example transmitting/receiving device that communicates media stream packets over a pass through mechanism.

FIG. 3 is a diagram of example data packet structures.

FIG. 4 is a table of example stream identifiers included in data packet structures.

FIG. 5 is a flow chart for communicating media stream packets over a pass through mechanism between transmitting and receiving devices.

### DETAILED DESCRIPTION

### Overview

Described herein are architectures, platforms and methods that allow a media stream packet defined by a first format, for example the MPEG specification, to be passed through and encapsulated in a packet defined by a second format, for example the WiGig specification.

Example System Environment

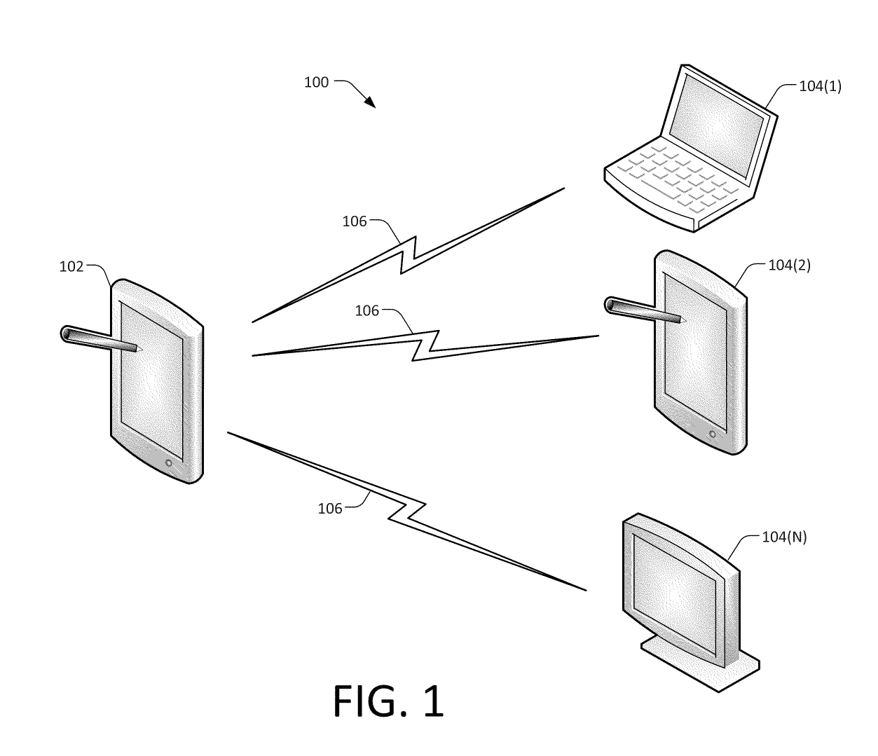

FIG. 1 illustrates a system-level overview of an exemplary system environment 100 for communicating media stream packets. For example, the media stream packets may be MPEG stream packets (e.g., MPEG audio video or MPEG AV stream packets), wireless display or WiDi stream packets, or Internet Protocol (IP) stream packets. In particular, the media stream packets may be communicated using a pass through mechanism, such as an audio video protocol adaptation layer (AV PAL) between transmitting and receiving devices.

The system environment 100 may be one of various wireless network environments, such as a wireless local area network or WLAN. The system environment 100 includes devices 102 and 104 that may be multi-band. The term multi-band is commonly used to refer to devices that support operation in multiple frequency bands, such as 2.4 GHz, 5 GHz, cellular bands, among others. Although these devices are multi-band from a frequency band point of view, from radio implementation and system integration perspective the operation across the supported frequency bands are completely independent. In other words, there is no means for information/resource sharing and for seamless transfer of communication at the data link level.

To address this problem, the WiGig and IEEE 802.11ad specifications have defined a multi-band operation mechanism that allows integration and seamless operation across different frequency bands and channels. This multi-band mechanism, also known as fast session transfer (FST), is becoming a key component in future generation 60 GHz based systems, and is expected to significantly improve the user experience by offering real-time integration at the data link level between different WiGig-based and IEEE 802.11-based technologies. Although the 60 GHz frequency spectrum has been identified in this example, it is understood that other frequency spectrums may be implemented.

The system environment 100 includes transmitting device 102 that generates or passes media stream packets over a pass through mechanism, such as MPEG AV bit streams over an AV PAL. In particular, the transmitting device 102 supports a defined transmission format such, such as WiGig transmission. Transmitting device 102 may also be a receiving device that receives media streams (e.g., MPEG AV bit streams) over a pass through mechanism (e.g., AV PAL). Device 102 may include various devices, such as laptop computers, tablets, smart phones, desktop computers, etc. In general device 102 may be a transmitting (or receiving) device that implements a platform defined by a particular format (e.g., MPEG platform) and communicates using a different or second format (i.e., the IEEE 802.11ad or WiGig specification), as described further below. In particular, the media stream packets are wrapped with headers of defined by the second format to create an encapsulated payload defined by the second format to create data packet for transmission.

In this example, the data packets for transmission from transmitting device 102 are transmitted over a wireless transmission as represented by wireless links 106. As discussed, the transmission of wireless links 104 may be over a 60 GHz frequency spectrum.

According to some embodiments of the invention, devices 102 and 104 may perform a direct link communication over wireless links 106. Device 102 may ask device(s) 104 to change its transmission power, if desired. Devices 102 and 104 may include multiple antenna elements (e.g., a phase array antenna). A beamforming (BF) algorithm may be used to determine an optimal antenna configuration for exchanging data between devices 102 and 104. For example, device 102 may use a link measurement procedure to measure a link quality of wireless link 106, if desired. According to embodiments of the invention, wireless link 106 is a directional wireless link at 60 Ghz frequency band. Devices 104 may insert the link quality information in a DBand Link Margin information element, if desired.

Receiving devices 106 may also be transmitting, or transmitting/receiving devices, such as device 102. In this example, devices 106 receive transmitted data packets with the encapsulated payload. In certain embodiments, the devices 106 implement or include a pass through mechanism, such as an AV PAL, that receives and processes the media stream packets.

Example Transmitting/Receiving Device

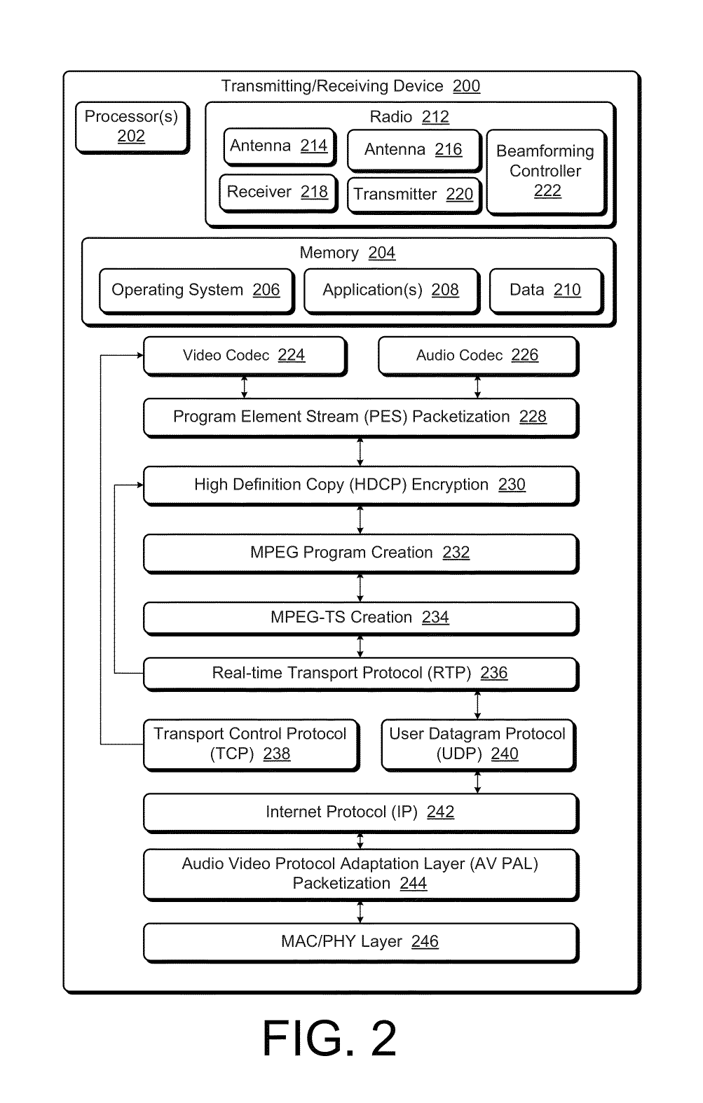

FIG. 2 shows an example transmitting/receiving device 200 that communicates MPEG streams over audio video protocol adaptation layer. Device 200 includes one or more processors, processor(s) 202. Processor(s) 202 may be a single processing unit or a number of processing units, all of which may include single or multiple computing units or multiple cores. The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 may be configured to fetch and execute computer-readable instructions or processor-accessible instructions stored in a memory 204 or other computer-readable storage media.

Memory 204 is an example of computer-readable storage media for storing instructions which are executed by the processor(s) 202 to perform the various functions described above. Memory 204 may include one or more of volatile memory, non-volatile memory, removable or non-removable memory, erasable or non-erasable memory, writeable or re-writeable memory, and the like. For example, memory 204 may include one or more random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like.

Memory 204 may be referred to as memory or computer-readable storage media herein. Memory 204 is capable of storing computer-readable, processor-executable program instructions as computer program code that may be executed by the processor(s) 202 as a particular machine configured for carrying out the operations and functions described in the implementations herein.

Memory 204 may include an operating system 206, and may store application(s) 208. The operating system 206 may be one of various known and future operating systems implemented for personal computers, audio video devices, etc. The applications(s) 208 may include preconfigured/installed and downloadable applications. In addition, memory 204 can include data 210.

The transmitting/receiving device 200 may include communication interface(s), and particularly a radio 212. Radio 212 may be operably coupled to two or more antennas. For example radio 212 may operably couple to antennas 214 and 216. Radio 212 may include at least a receiver (RX) 218, a transmitter (TX) 220 and a beamforming (BF) controller 222, although the scope of the present invention is not limited in this respect. The transmitting/receiving device 200 further includes a “stack” for processing and transmitting media bit stream packets. The stack is described in a transmitting context; however, it will be known to those in the art that the process performed by the stack can be reversed to receive media bit stream packets. For example, elements/modules in the stack that may be described as performing an “encoding” function during a transmission, may be “decoding” when receiving a bit stream. This particular example describes processing MPEG AV bit stream packets; however, it is noted that other media bit stream packets may be implemented, for example, wireless display or WiDi stream packets, or Internet Protocol (IP) stream packets.

The stack includes a video coder decoder (codec) 224 for receiving and processing video data, and an audio codec 226 for receiving and processing audio data. Video and Audio from video codec 224 and audio codec 226 are received by a program element stream (PES) packetization module 228. The packetized data from PES packetization module 228 is sent to a high definition copy protection (HDCP) encryption module 230 that may add copyright protection to the data. The data may be passed on to an MPEG program creation module 232, where an MPEG packet is created. The MPEG packet may then be sent to an MPEG-Transport Stream (TS) creation module 234 for formatting for delivery over the defined MPEG-TS specification. In other implementations, MPEG-PS is used rather than MPEG-TS. The packet from the MPEG-TS creation module 234 may be sent to a real-time transport protocol (RTP) module 236. In certain implementations, MPEG-TS (or MPEG-PS) streams may be directly sent over a pass through mechanism without IP packetization, as shown below.

A transport control protocol (TCP) module 238 may provide control messages for the HDCP encryption module 230, and a real time transport control protocol (RTCP) control/feedback input to the video codec 224 and audio codec 226. In certain embodiments, a real-time transport session protocol (RTSP) module (not shown) may be implemented to provide device 200 session management input.

Data from RTP module 236 may be sent to a user datagram protocol (UDP) module 240. The UDP module 240 passes the data for further processing by an Internet protocol (IP) module 242. The data from the IP module 242 may be seen as an MPEG packet that can be processed by an MPEG specification platform.

The MPEG packet from IP module 242 is received by the pass through mechanism. In this example, the pass though mechanism is an AV PAL packetization module 244. The AV PAL packetization module 244 conforms to the IEEE 802.11ad or WiGig transmission specification for communicating AV bit streams or streams. In particular, the AV PAL packetization module 234 processes MPEG packets into a WiGig formatted packets that can be sent and received using WiGig specifications. Examples of such WiGig formatted packets are further described below.

The WiGig formatted packet form AV PAL packetization module 234 may be passed on to a media access control/physical (MAC/PHY) layer 236 for further processing and eventually transmission. The MAC/PHY layer 236 can be defined by the 802.11ad or WiGig specification.

The example transmitting/receiving device 200 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

Example Data Packet Structures

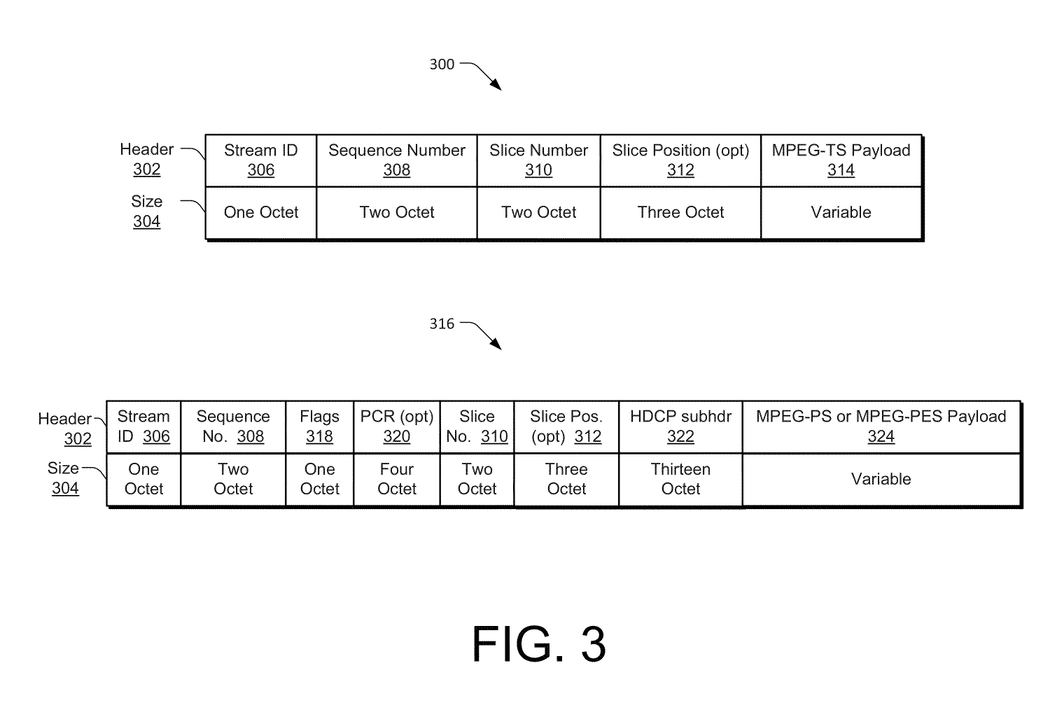

FIG. 3 shows examples of example data packet structures. In this example, the MPEG specification and IEEE 802.11ad or WiGig specification are described. The IEEE 802.11ad or WiGig specification is designed to communicate relatively larger data packets than MPEG specification packets, where a MPEG-TS packet may have a 188 byte size. The MPEG packet or payload may be included in a WiGig data packet. The described data packet structures may be transmitted over a radio, otherwise described above as radio 212.

Data packet structure 300 shows an example of an MPEG-TS payload carried in an AV PAL packet. Data packet structure 300 includes various data fields defined by a header 302, where each field has a particular size 304. Size 304 is defined by an octet or eight bit word. Data packet structure 300 may be defined by the IEEE 802.11ad or WiGig specification. In this example, data structure 300 includes a stream ID field 306 having a field size of one octet; a sequence number field 308, having a field size of two octets; a slice number field 310, having a field size of two octets; an optional slice position field 312 having a field size of three octets; and an MPEG-TS payload field 314, having a variable size field. As discussed above, an MPEG-TS payload may be a 188 byte packet. Stream ID field 306 may be consistent with the “stream id extension field” as defined by the H.222 specification as provided by the MPEG specification.

When receiving and decoding received AV bit stream packets, a receiving device parses headers of the received data AV bit stream data packet. In order to minimize parsing of headers in received data packets, a larger payload may be sent.

Data packet structure 316 shows an example of a data packet structure larger. In this example, in addition to stream ID field 306, sequence number field 308, slice number field 310, and optional slice position field 312, data packet structure 316 may include a flags field 318, having a field size of one octet, an optional program (element) stream clock reference (PCR) field 320, having a four octet field; and a HDCP sub header field 322, having a thirteen octet field. Data packet structure 316 includes an MPEG PS or MPEG-PES payload field 324 having a variable field size. The MPEG PS or MPEG-PES payload field 324 conforms to the H.222 specification as provided by the MPEG specification. In certain implementations, the PCR field 320 and HDCP sub header field 322 may be embedded in the MPEG PS or MPEG-PES payload field 324, and are not included in the data packet structure 316.

Example Stream ID Values

In certain implementations, it may be desirable to make use of existing defined MPEG stream identifiers. For example, compressed/uncompressed data and wireless service provider or WSP (a special WiGig video mode) may be identified using a known MPEG stream ID value. In particular, the stream ID field 306 of the described data packet structures, may provide the data which is a reuse of preexisting MPEG stream IDs.

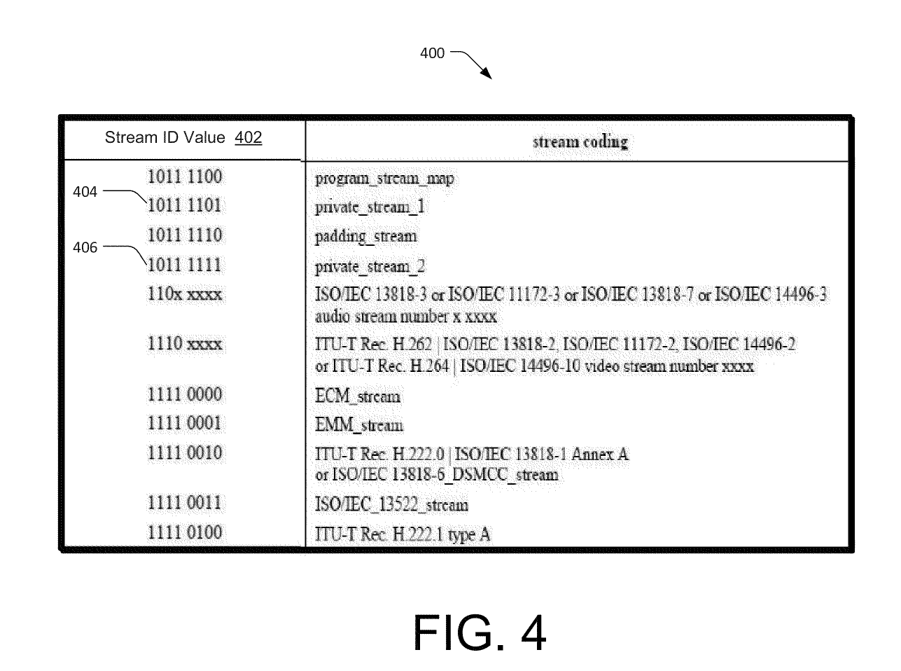

FIG. 4 shows example stream identifiers. Such stream identifiers may be included in the MPEG H.222 specification. The table 400 includes a stream ID value header 402. In this example, the value 404, which is “1011 1101” used to define a private stream may be used to define an uncompressed stream. The value 1011 1111, another private stream may be used to identify WSP video mode.

Example Process

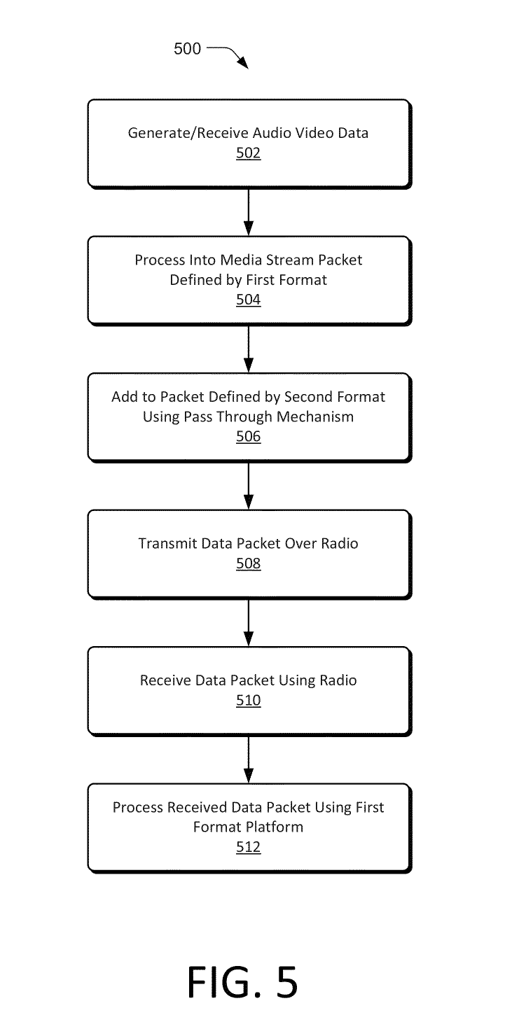

FIG. 5 shows a flow chart for an exemplary process 500 for communicating media stream packets over a pass through mechanism between transmitting and receiving devices. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, generating or receiving audio and video data is performed. The audio and video data is to be processed and communicated as a bit stream or stream of data from a device to another device(s). As described above, the audio and video data may be received as separate data. In certain implementations, the audio and video is received by the device.

At block 504, processing of the audio video data into a media stream packet is performed. In certain embodiments the media stream packet may be wireless display or WiDi packets or Internet protocol (IP) packets. Particular implementations may use an MPEG specification based platform. In particular, the described stack above may be used to generate a MPEG specification based bit stream. The MPEG specification based bit stream may include an MPEG-TS, or MPEG-PS/MPEG-PES data packet or payload.

At block 506, adding payload of the media steam packet is added or encapsulated to packet defined by a second format. For example, an MPEG data payload may be added to a WiGig specification data packet. The adding may be performed using a pass through mechanism, such as an AV PAL as defined by the WiGig specification, and described above. In particular, the adding may include wrapping headers (e.g., AV PAL headers) with the payload (e.g., MPEG data payload). Particular headers of the WiGig specification data packet may include previously defined MPEG identifiers.

At block 508, transmitting the packet is performed over a radio. For example, a WiGig data packet with the MPEG payload is performed over a WiGig Radio. The WiGig Radio as discussed above may operate using the 60 GHz frequency spectrum or other frequency spectrum.

At block 510, receiving the packet is performed over a radio. For example, receiving WiGig data packet with an encapsulated MPEG payload is performed by a WiGig radio as described above.

At block 512, processing the data packet is performed. In particular, a pass through mechanism, such as an AV PAL at the receiving device, receives the data packet (e.g, WiGig data packet). Headers of the data packet (e.g., WiGig data packet) may be parsed, and the encapsulated payload (e.g., MPEG payload) exposed. The payload may then be further processed by the format that defines the standard. For example, an MPEG payload may be processed by an MPEG specification platform.

What is claimed is:

1. A method performed by a device for transmitting a media stream packet comprising:
generating the media stream packet as defined by a first format;
wrapping the media stream packet with defined headers of second format, using a pass through mechanism to create a packet defined by the second format which includes payload of the media stream; and
transmitting the packet defined by the second format over a radio defined by the second format of the device.

2. The method of claim 1 wherein the media stream packet is one of a Moving Pictures Expert Group (MPEG), Wireless Display (WiDi), or Internet Protocol (IP) packet.

3. The method of claim 1 wherein generating is performed using a platform defined by the first format of the device.

4. The method of claim 3 wherein the platform is a Moving Pictures Experts Group (MPEG) protocol stack.

5. The method of claim 1 wherein the pass through mechanism is an audio video adaptation layer.

6. The method of claim wherein the wrapping includes providing stream identifiers based on identifiers of the first format.

7. The method of claim 1 wherein the transmitting is over a 60 GHz frequency spectrum.

8. A device comprising:
one or more processors;
memory configured to the one or more processors; and
a stack configured to the memory the one or more processors that includes:
a platform to process media stream packets defined by a first format; and
an pass through mechanism to wrap the media stream packets with headers defined by a second format to create a data packet defined by a second format; and
a wireless interface to transmit the data packet defined by the second format.

9. The device of claim 8, wherein the device includes a smart phone, laptop computer, and tablet computer.

10. The device of claim 8 wherein the platform includes a protocol stack defined by the first format.

11. The device of claim 8 wherein the stack is part of the memory.

12. The device of claim 8 wherein the pass through mechanism is an audio video protocol adaptation layer.

13. The device of claim 8 wherein the pass through mechanism implements stream identifiers defined by the first format in a stream identifier header.

14. The device of claim 8 wherein the wireless interface operates in 60 GHz frequency spectrum.

15. The device of claim 8 further comprising a media access control layer and physical layer that includes the pass through mechanism.

16. A method performed by a device for receiving a payload defined by a first format encapsulated by a data packet defined by a second format comprising:
receiving the data packet through a wireless interface;
parsing headers defined by the second format from the data packet;
generating the payload defined by the first format from the data packet; and
processing the payload defined by the first format.

17. The method of claim 16 wherein the wireless interface is a radio operating at a frequency spectrum of 60 GHz.

18. The method of claim 16 wherein the parsing is performed by an audio video protocol adaptation layer.

19. The method of claim 16 wherein the processing is performed by a protocol stack defined by the first format.

20. The method of claim 19 wherein the protocol stack is defined by the Moving Pictures Experts Group.
